(19) United States
(12) Patent Application Publication
(10) Pub. No.: US 2009/0263767 A1
(43) Pub. Date: Oct. 22, 2009

(54) Method for Charting Astrological Events

(76) Inventor: Charles Micovich, Redford, MI (US)

Correspondence Address: PATWRITE LLC, 408 W. MAIN ST., MARSHALLTOWN, IA, 50158-5759, US

(21) Appl. No.: 12/130,713

(22) Filed: May 30, 2008

Related U.S. Application Data
(60) Provisional application No. 60/932,175, filed on May 30, 2007.

(51) Int. Cl. G09B 19/00

(52) U.S. Cl. 434/106

(57) ABSTRACT

A method of charting astrological events comprises the steps of obtaining a user's date of interest which is often a birthdate and using the date to chart the position of celestial objects at the date of interest on an astrological chart divided into 12 equal segments. The user selects a celestial object of interest such as Mercury etc. and rotates the alignment until the object is on the zero point. The user then looks at specific angles called crucial points or secondary crucial points which coincide with 45 degree increments from the zero point. Crucial events are determined by the presence of celestial objects such as the Sun or Moon appearing in those crucial points. The method is repeated for another celestial object of interest by rotating until the other celestial object is at the zero point. In one embodiment, a computer is used to calculate and rotate the chart.

### RELATED APPLICATIONS

This application claims priority and herein incorporates by reference U.S. provisional patent application 60/932,175, filed May 30, 2007.

### BACKGROUND OF THE INVENTION

Humans have a universal need to know. Early humans looked to the sky to understand the world around them. The belief that the heavens are involved in the destiny of humans is central to the practice known as Astrology. Throughout human history, societies have always had those who seemed to be in tune with the forces in nature.

Most astrological systems use a person's birthdate to chart the position of the planets, sun and moon and use that information to predict and understand a person's life. Astrologers believe that the position of celestial objects control or at least influence the events in a person's life and that through a proper reading, much can be revealed to an individual that will help them plan and improve their life. Often the systems are complex and the rules of interpretation are difficult to understand. Additionally, since most societies have had similar beliefs, various forms of astrology have been developed including what could be categorized as Western thought and Eastern thought. There is a need for a method of charting astrological events in a way that is easy to understand and allows a user to concentrate on events that have the most impact.

### SUMMARY OF THE INVENTION

A method of charting astrological events comprises the steps of obtaining a user's date of interest which is often a birthdate and using the date to chart the position of celestial objects at the date of interest on an astrological chart divided into 12 equal segments. The user selects a celestial object of interest such as Mercury etc. and rotates the alignment until the object is on the zero point. The practitioner then looks at specific angles called crucial points or secondary crucial points which coincide with generally 45 degree or 60 degree increments from the zero point. Crucial events are determined by the presence of celestial objects such as the Sun or Moon appearing near those crucial points. The method is repeated for another celestial object of interest by rotating until the other celestial object is at the zero point. In one embodiment, a computer is used to calculate and rotate the chart.

Other features and advantages of the instant invention will become apparent from the following description of the invention which refers to the accompanying drawings.

### BRIEF DESCRIPTION OF THE DRAWINGS

FIG. 1 is an astrological chart prepared according to an embodiment of the present invention.

FIG. 2 is an astrological chart prepared according to an embodiment of the present invention.

FIG. 3 is an astrological chart prepared according to an embodiment of the present invention.

FIG. 4 is an illustration showing the crucial points according to an embodiment of the present invention.

FIG. 5 is an illustration showing other crucial points according to an embodiment of the present invention.

FIG. 6 is a flow diagram of the method of charting an astrological event according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

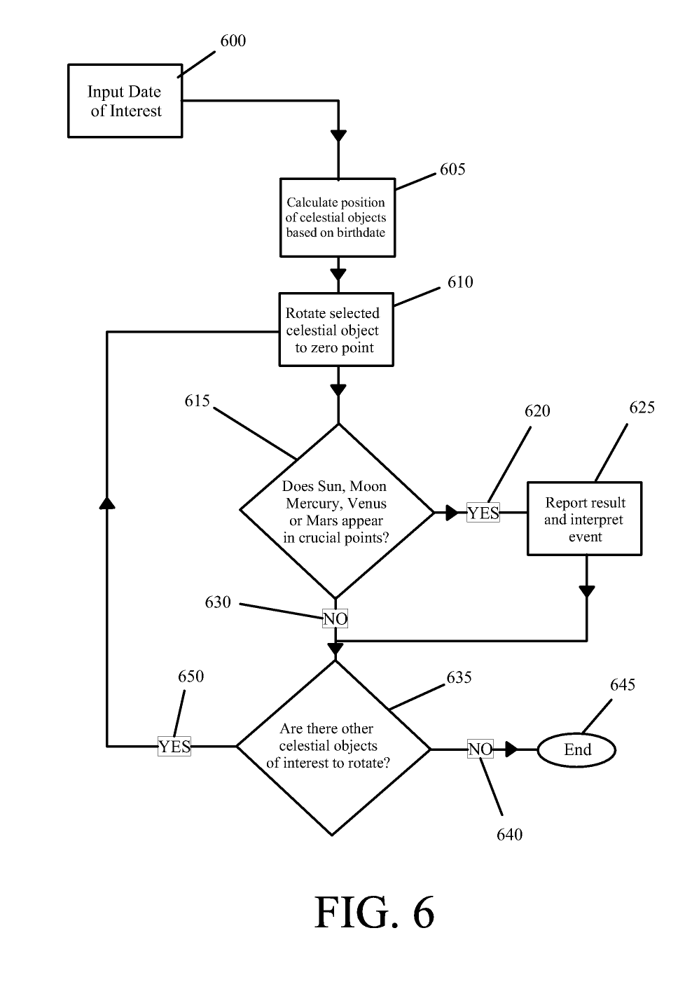

FIG. 6 is a flow chart showing the steps of a method of charting an astrological event according to an embodiment of the present invention and comprises the following steps. A date of interest is inputted 600 and is used to calculate the position of celestial objects 605 as they appeared on the date of interest. The date of interest includes at least the day, month and year, but may also include a specific time if a more in depth reading is desired.

Next, the positions of the celestial objects are rotated as a whole to a zero point on a chart 610. This rotation maintains the relative orientation of the objects to each other but transposes them to the zero point. This rotation 610 may be performed “by hand” on a chart or by using an appropriate computer program as is known in the art. If the Sun, Moon, Mercury, Venus or Mars or a combination thereof appear near or in crucial points 615, 620 then the results of the alignment are reported to a user 625. The reporting can be orally reported by a practitioner of the present invention or by displaying a result on an electronic output device such as a computer monitor or speaker as is known in the art.

If the answer to question 615 is NO 630, then a question as to whether there are other objects of interest left to rotate 635 is answered. If the answer is NO 640, the method ends 645. If there are still celestial objects left to rotate 650, step 610 is repeated until the answer is NO 630 and the method ends 645.

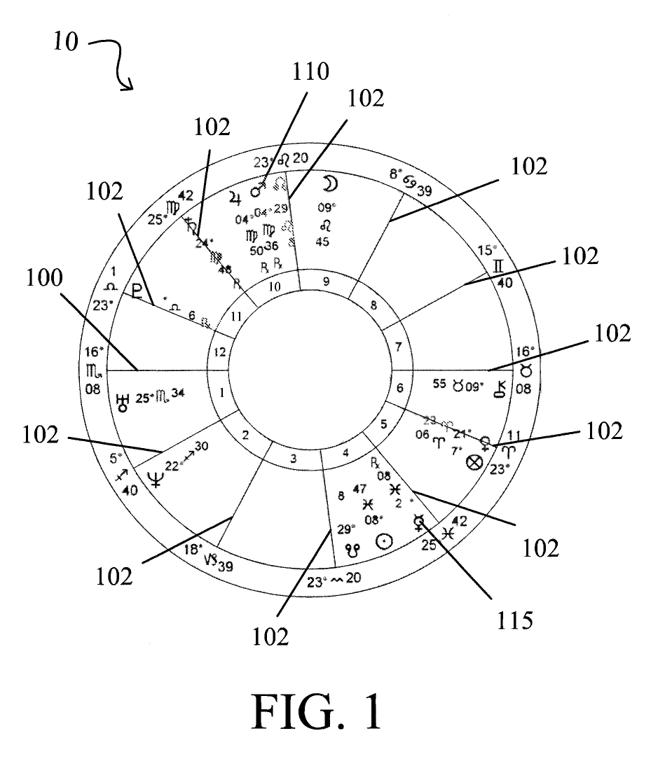

Referring to FIGS. 1-3, astrological charts prepared according to an embodiment of the present invention are prepared by obtaining and plotting the position of the celestial objects on a chart 10. As an example, Mars 110 and Mercury 115 are specifically shown aligned as they appeared on the date of interest, generally a birthdate, on FIG. 1. Throughout the method, the relative positions of the celestial objects maintain their spatial relationship. Chart 10 is divided into 12 equal areas 102 often called Houses in the astrological field of study. A special point of interest is called the Zero Point 100 and is also known as the Aries Point. It is the reference point used in the instant invention.

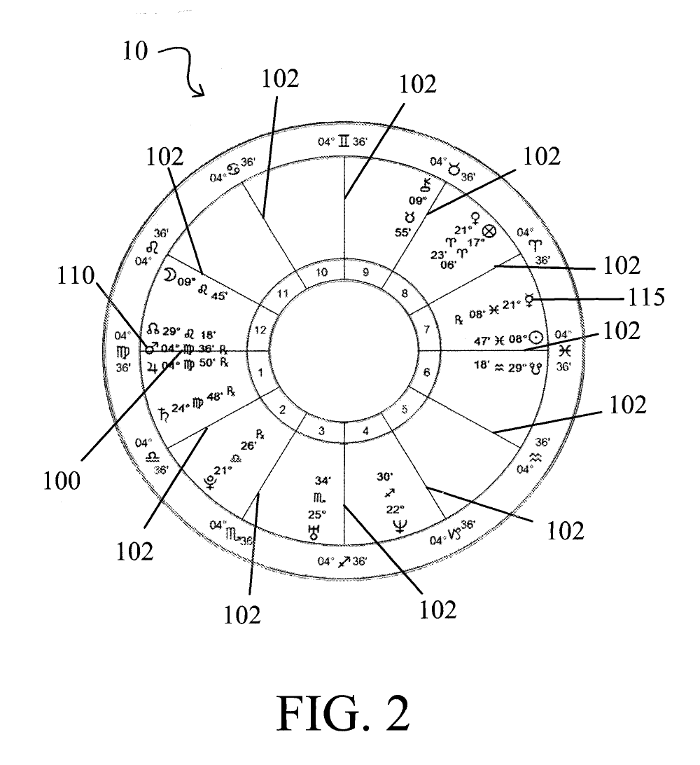

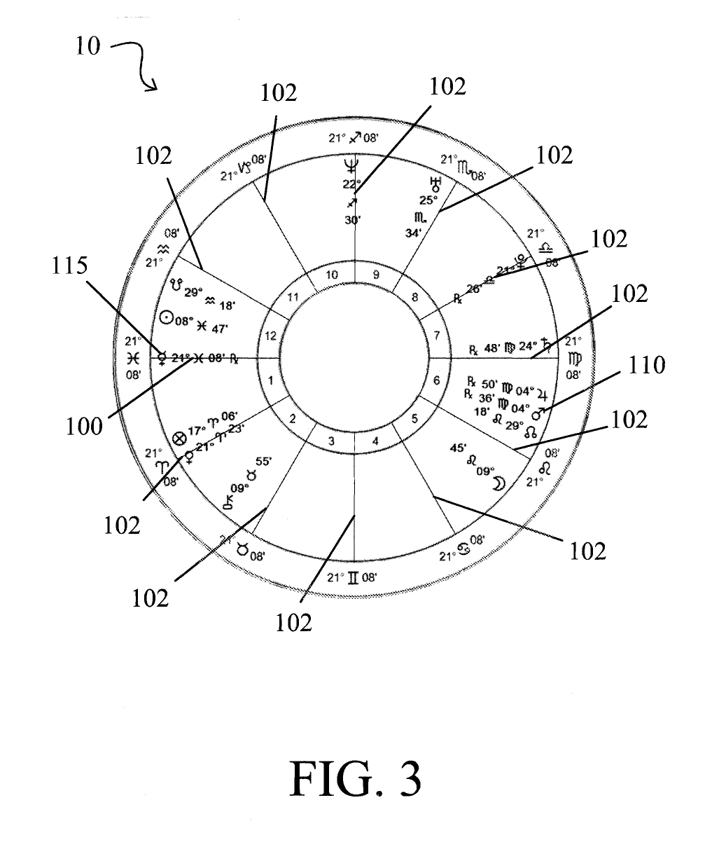

In FIG. 2, Mercury 110 is rotated until it is aligned with Zero Point 100. In FIG. 3, the rotation moves Mercury 115 to Zero Point 100. The method repeats for other celestial objects such as Venus, Mars or the Moon.

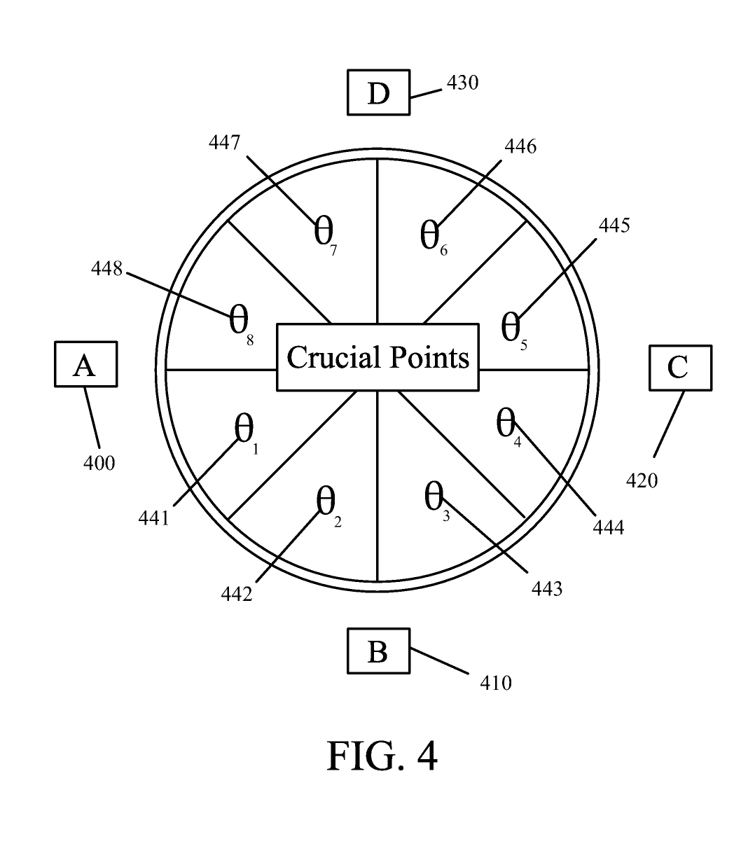

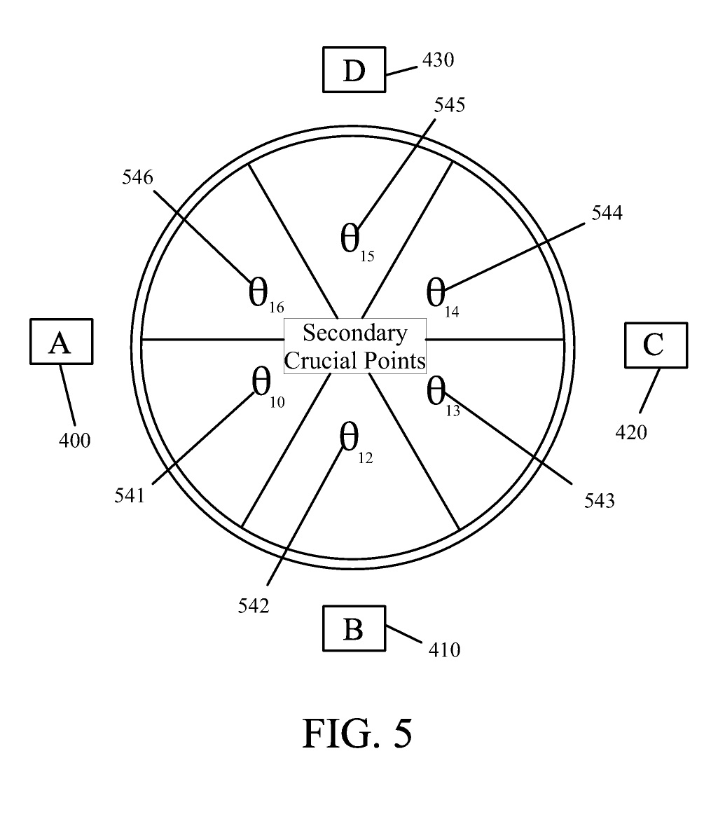

Now referring to FIGS. 4 and 5, Crucial Points are examined to identify events of interest such as critical life decisions, deaths, births etc. Position A 400 represents Zero point 100 with angles θ₁ 441, θ₂ 442, θ₃ 443, θ₄ 444, θ₅ 445, θ₆ 446, θ₇ 447 and θ₈ 448 being generally 45 degrees each. Position B 410 is 90 degrees from position A 400 and represents events relating to heart or home. Position C 420 is 180 degrees from position A 400 and represents who is involved in the identified crucial event. Position D 430 is 270 degrees from Position A 400 and represents when the event may become publically revealed.

FIG. 5 illustrates secondary crucial points appearing at θ₁₀ 541, θ₁₁ 542, θ₁₂ 543, θ₁₄ 544, θ₁₅ 545 and θ₁₆ 546 which are generally 60 degrees from each other. As before, these areas represent events when the Sun and/or Moon appear in these areas after rotating a celestial object 110, 115 or others to zero point 100. The method may be repeated for other dates and for as many celestial objects as desired.

Although the instant invention has been described in relation to particular embodiments thereof, many other variations and modifications and other uses will become apparent to those skilled in the art.

What is claimed is:

1. A method of astrologically calculating an event for a user comprising the steps of:
selecting a date of interest;
locating the positions of the Sun, Moon and planets at said selected date of interest;
marking said positions of the Sun, Moon and planets on an astrological chart having 12 equal divisions;
selecting one of said positions of the Sun, Moon and planets;
rotating said selected position to a zero point;
looking for an event of interest when at least one of the Sun, Moon, Mercury, Venus and Mars is generally at a selected angle referenced from said zero point;
selecting another of said positions of the Sun, Moon and planets and rotating said selected another position to said zero point; and
looking for an event of interest when at least one of the sun, Moon, Mercury, Venus and Mars is generally at said selected angle.

2. The method of astrologically calculating an event for a user according to claim 1 wherein said date of interest is a birthdate.

3. The method of astrologically calculating an event for a user according to claim 2 wherein said birthdate also includes the time of birth.

4. The method of astrologically calculating an event for a user according to claim 1 wherein said selected angle is −45 degrees from said zero point.

5. The method of astrologically calculating an event for a user according to claim 1 wherein said selected angle is −90 degrees from said zero point.

6. The method of astrologically calculating an event for a user according to claim 1 wherein said selected angle is −135 degrees from said zero point.

7. The method of astrologically calculating an event for a user according to claim 1 wherein said selected angle is −180 degrees from said zero point.

8. The method of astrologically calculating an event for a user according to claim 1 wherein said selected angle is −225 degrees from said zero point.

9. The method of astrologically calculating an event for a user according to claim 1 wherein said selected angle is −270 degrees from said zero point.

10. The method of astrologically calculating an event for a user according to claim 1 wherein said selected angle is −315 degrees from said zero point.

11. The method of astrologically calculating an event for a user according to claim 1 wherein said selected angle is −60 degrees from said zero point.

12. The method of astrologically calculating an event for a user according to claim 1 wherein said selected angle is −120 degrees from said zero point.

13. The method of astrologically calculating an event for a user according to claim 1 wherein said selected angle is −180 degrees from said zero point.

14. The method of astrologically calculating an event for a user according to claim 1 wherein said selected angle is −240 degrees from said zero point.

15. The method of astrologically calculating an event for a user according to claim 1 wherein said selected angle is −300 degrees from said zero point.

16. A method of astrologically calculating an event for a user comprising the steps of:
selecting a date of interest;
inputting said selected date of interest to a means for locating and marking the positions of the Sun, Moon and planets at said selected date of interest on an astrological chart having 12 equal divisions;
selecting one of said positions of the Sun, Moon and planets;
inputting said selected one of said position of the Sun, Moon and planets to a means for rotating said selected position to a zero point;
outputting an event of interest when at least one of the Sun, Moon, Mercury, Venus and Mars is generally at a selected angle referenced from said zero point;
selecting another of said positions of the Sun, Moon and planets;
inputting said selected another of said position of the Sun, Moon and planets to said means for rotating said selected another position to a zero point; and
outputting an event of interest when at least one of the Sun, Moon, Mercury, Venus and Mars is generally at a selected angle.

17. The method of astrologically calculating an event for a user according to claim 16 wherein said means for locating and marking the positions of the Sun, Moon and planets at said selected date of interest on an astrological chart having 12 equal divisions is a computer with an appropriate software program therein.

18. The method of astrologically calculating an event for a user according to claim 16 wherein a means for rotating said selected position to a zero point is a computer with an appropriate software program therein.

19. The method of astrologically calculating an event for a user according to claim 16 wherein the step of outputting an event of interest when at least one of the Sun, Moon, Mercury, Venus and Mars is generally at a selected angle referenced from said zero point includes displaying said event on an electronic imaging device.

20. The method of astrologically calculating an event for a user according to claim 16 wherein the step of outputting an event of interest when at least one of the Sun, Moon, Mercury, Venus and Mars is generally at a selected angle referenced from said zero point includes displaying said event on a printer.
